(19) United States
(12) Patent Application Publication
(10) Pub. No.: US 2012/0236130 A1
(43) Pub. Date: Sep. 20, 2012

(54) VIDEO OUTPUT DEVICE

(75) Inventors: Shuji ISHII, Daito-shi (JP); Chuichi NOHARA, Daito-shi (JP)

(73) Assignee: Funai Electric Co., Ltd., Osaka (JP)

(21) Appl. No.: 13/411,883

(22) Filed: Mar. 5, 2012

(30) Foreign Application Priority Data
Mar. 14, 2011 (JP) 2011-055764

(51) Int. Cl. H04N 13/04

(52) U.S. Cl. 348/51; 348/E13.075

(57) ABSTRACT

A video output device that is capable of luminance adjustment while preventing signal degradation includes a display unit which respectively displays a left eye image that is transmitted to the left eye and a right eye image that is transmitted to the right eye and which also outputs, by insertion between the left-eye image and the right-eye image, a black image that lowers luminance and does not contribute to the display, and a control unit that controls and adjusts the luminance by adjusting an insertion time of the black image inserted between the left-eye image and the right-eye image displayed on the display unit.

### BACKGROUND OF THE INVENTION

1. Field of the Invention

The present invention relates to a video output device, and particularly relates to a video output device including a display unit.

2. Description of the Related Art

Video output devices equipped with a display unit have conventionally been known (see Japanese Patent Application Laid-Open Publication No. 2010-266852, for example).

Japanese Patent Application Laid-Open Publication No. 2010-266852 discloses a 3D video display device (video output device) equipped with a liquid crystal panel (display unit) on which an image for the left eye that is transmitted to the left eye and an image for the right eye that is transmitted to the right eye are alternately displayed at specified cycles. With this 3D video display device, by using glasses equipped with a liquid crystal shutter driven synchronously with the specified cycles of the left-eye image and the right-eye image to observe the left-eye image and the right-eye image, it is possible to view 3D video. With the aforementioned 3D video display device, furthermore, the constitution is such that a black image which does not contribute to the display is inserted for a fixed period of time between the display of the left-eye image and the display of the right-eye image. Consequently, the occurrence of the phenomenon of a portion of the left-eye image leaking to the right eye or the phenomenon of a portion of the right-eye image leaking to the left eye (crosstalk) can be suppressed by the insertion of the black image. Moreover, as a result of the black image being inserted between the display of the left-eye image and the display of the right-eye image, display is performed in a state in which the luminance of the display unit displaying the left-eye image and the right-eye image is lowered to a fixed luminance (maintained state) for the fixed period of time during which the black image is inserted. Note that the luminance of the display unit can conceivably be adjusted by performing signal processing of the left-eye image and the right-eye image using a contrast amp or the like.

However, with the 3D video display device described in Japanese Patent Application Laid-Open Publication No. 2010-266852, while the insertion of a black image between the display of the left-eye image and the display of the right-eye image makes it possible to suppress the occurrence of crosstalk, there is also a disadvantage in that it is difficult to adjust the luminance because the black image is inserted for a fixed period of time, the luminance of the display unit is maintained at a fixed luminance. In addition, in the case of using a contrast amp or the like in order to adjust the luminance, the problem of signal degradation also occurs due to signal processing.

### SUMMARY OF THE INVENTION

In view of the problems described above, preferred embodiments of the present invention provide a video output device for which luminance can be adjusted while preventing degradation of the signals.

A video output device according to a preferred embodiment of the present invention includes a display unit which respectively displays a left eye image that is transmitted to the left eye and a right eye image that is transmitted to the right eye and which also outputs, by insertion between the left-eye image and the right-eye image, a luminance adjustment image to lower luminance and that does not contribute to the display; and a control unit that controls and adjusts the luminance by adjusting an insertion time of the luminance adjustment image inserted between the left-eye image and the right-eye image displayed on the display unit.

In the video output device according to the present preferred embodiment, by providing a control unit which performs control such that the luminance is adjusted by adjusting the insertion time of the luminance adjustment image inserted between the left-eye image and the right-eye image displayed on the display unit, unlike the case of using a contrast amp or the like in order to adjust the luminance, signal processing of the left-eye image and the right-eye image is not performed, so it is possible to adjust the luminance of the display unit by adjusting the insertion time of the luminance adjustment image while preventing degradation of the signals of the left-eye image and the right-eye image.

In the video output device according to a preferred embodiment of the present invention, the control unit is preferably programmed and arranged to perform control which adjusts the insertion time of the luminance adjustment image following luminance adjustment to be longer than the insertion time of the luminance adjustment image prior to luminance adjustment, thereby adjusting the post-adjustment luminance to be lower than the pre-adjustment luminance, and which also adjusts the insertion time of the luminance adjustment image following luminance adjustment to be shorter than the insertion time of the luminance adjustment image prior to luminance adjustment, thereby adjusting the post-adjustment luminance to be higher than the pre-adjustment luminance. As a result, it is possible to make a difference between the luminance prior to adjustment and the luminance following adjustment, so the luminance of the display unit can be adjusted easily.

In the video output device according to a preferred embodiment of the present invention, the luminance adjustment image includes a black image, and the control unit is programmed and arranged to perform control which adjusts the luminance by adjusting the insertion time of the black image inserted between the left-eye image and the right-eye image. By being constituted in this way, it is possible to adjust the luminance of the display unit on which the left-eye image and the right-eye image are displayed according to the insertion time of the black image.

In this case, preferably, the control unit is programmed and arranged such that when adjusting the luminance, the control unit performs control which adjusts the display time of the left-eye image and the right-eye image and which also adjusts the insertion time of the black image according to the adjusted display time. As a result, it is possible to adjust the luminance of the display unit on which the left-eye image and the right-eye image are displayed according to the adjusted display time.

In a preferred embodiment of the video output device that adjusts the insertion time of the black image according to the adjusted time of the display time of the left-eye image and the right-eye image, preferably, the control unit is constituted so as to perform control which adjusts the luminance such that the total time of the display time of the left-eye image or the right-eye image plus the insertion time of the black image prior to luminance adjustment is substantially equal to the total time of the display time of the left-eye image or the right-eye image plus the insertion time of the black image following luminance adjustment. As a result, there is no change in the total time of the display time of the left-eye image or the right-eye image plus the insertion time of the black image prior to adjustment and following adjustment of the luminance, so it is possible to adjust the luminance of the display unit without performing control that changes the timing of the left-eye image display and the timing of the right-eye image display.

In a preferred embodiment of the video output device that outputs to the display unit the luminance adjustment image including the black image, preferably, an illuminance sensor capable of measuring illuminance is further provided, and the control unit is programmed and arranged to perform control which adjusts the luminance by adjusting the insertion time of the black image inserted between the left-eye image and the right-eye image based on the illuminance measured by the illuminance sensor. As a result, it is possible to adjust the luminance of the display unit easily based on the illuminance measured by the illuminance sensor.

In a preferred embodiment of the video output device that outputs to the display unit the luminance adjustment image including the black image, preferably, a luminance adjustment unit which allows the user to adjust the luminance is further provided, and the control unit is programmed and arranged to perform control which adjusts the luminance by adjusting the insertion time of the black image inserted between the left-eye image and the right-eye image according to the amount of adjustment of the luminance adjustment unit when the adjustment operation of the luminance adjustment unit is performed by the user. As a result, it is possible to adjust the luminance of the display unit easily according to the amount of adjustment of the luminance adjustment unit.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an overall view of the liquid crystal television device and glasses according to a first preferred embodiment of the present invention.

FIG. 2 is a block diagram of the liquid crystal television device and glasses according to the first preferred embodiment of the present invention.

FIG. 3 is a flow chart showing the control process flow of the liquid crystal television device according to the first preferred embodiment of the present invention.

FIG. 4 is a diagram for illustrating the display time of the left-eye image and right-eye image and the insertion time of the black image prior to adjustment of the luminance of the liquid crystal television device according to the first preferred embodiment of the present invention.

FIG. 5 is a diagram for illustrating the display time of the left-eye image and right-eye image and the insertion time of the black image following adjustment of the luminance of the liquid crystal television device according to the first preferred embodiment of the present invention.

FIG. 6 is a block diagram of the liquid crystal television device and glasses according to a second preferred embodiment of the present invention.

FIG. 7 is a flow chart showing the control process flow of the liquid crystal television device according to the second preferred embodiment of the present invention.

FIG. 8 is a diagram for illustrating the display time of the left-eye image and right-eye image and the insertion time of the black image prior to adjustment of the luminance by the contrast volume adjustment unit of the liquid crystal television device according to the second preferred embodiment of the present invention.

FIG. 9 is a diagram for illustrating the display time of the left-eye image and right-eye image and the insertion time of the black image following adjustment of the luminance by the contrast volume adjustment unit of the liquid crystal television device according to the second preferred embodiment of the present invention.

### DETAILED DESCRIPTION OF THE PREFERRED EMBODIMENTS

### First Preferred Embodiment

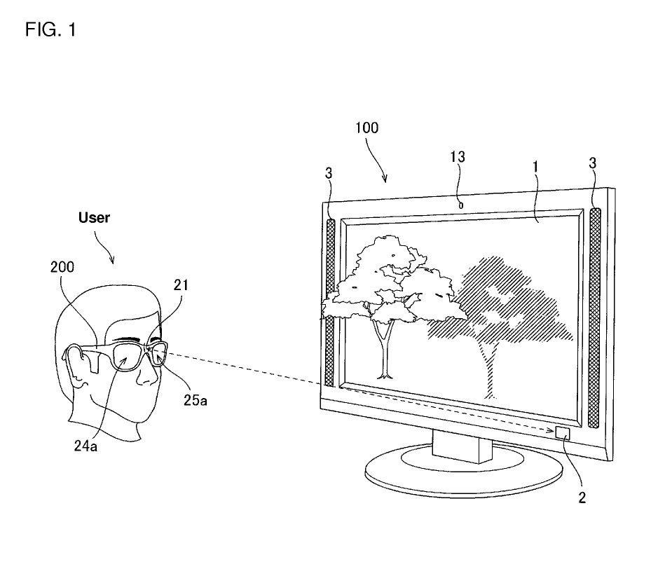

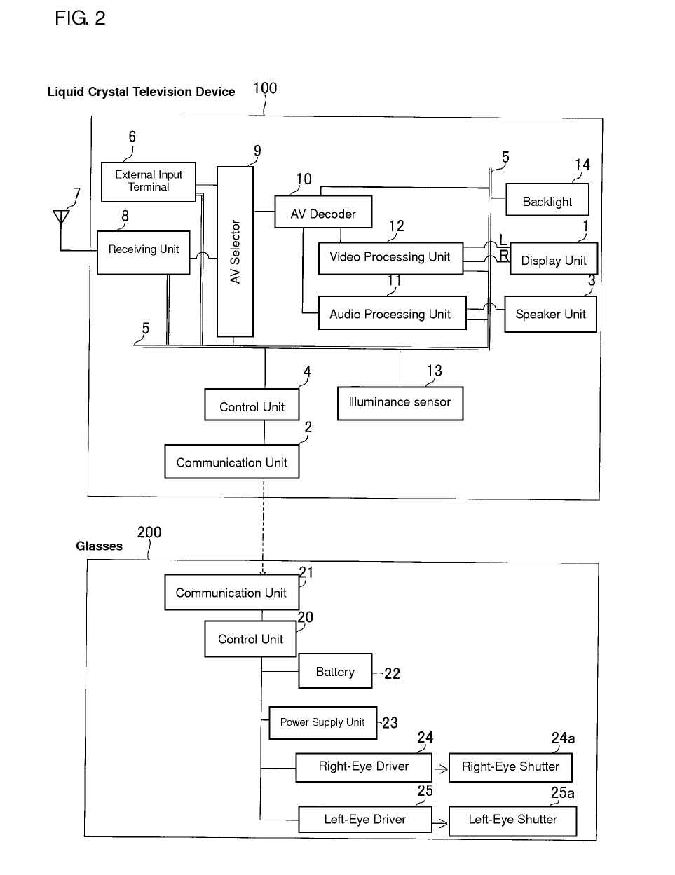

The constitution of a liquid crystal television device 100 according to a first preferred embodiment of the present invention will be described with reference to FIGS. 1 and 2.

As is shown in FIG. 1, the liquid crystal television device 100 according to the first preferred embodiment of the present invention preferably includes a display unit 1 that displays two-dimensional (2D) video and three-dimensional (3D) video, a communication unit 2 that performs wireless communication with glasses 200 via Bluetooth (registered trademark) or the like, and a speaker unit 3 that outputs audio. Furthermore, the glasses 200 are used to observe or view 3D video displayed on the display unit 1 of the liquid crystal television device 100.

Moreover, the display unit 1 is constituted so as to display an image for the left eye that is transmitted to the left eye of the user and an image for the right eye that is transmitted to the right eye. In addition, the display unit 1 is constituted so as to be able to display 3D video by alternately displaying the right-eye image and the left-eye image at specified time intervals. Furthermore, the display unit 1 is constituted so as to output and display a black image by insertion between the left-eye image and the right-eye image. This black image is an image that does not contribute to the display and has the function of lowering the luminance of the image including the left-eye image and right-eye image that is displayed on the display unit 1.

Moreover, as is shown in FIG. 2, the liquid crystal television device 100 includes a control unit 4 that performs overall control of the liquid crystal television device 100. In addition, the constitution is such that the control unit 4 and each component within the liquid crystal television device 100 can communicate control signals and control data with each other by being mutually connected by a bus (transmission path) 5.

Furthermore, the liquid crystal television device 100 is equipped with an external input terminal 6 to connect with a DVD recorder (recording and playback device) or the like, and a receiving unit 8 that receives digital television broadcast signals delivered from a broadcasting station via an antenna 7. Such an external input terminal 6 and receiving unit 8 are connected to an AV selector 9 having the function of switching input and output of video signals and audio signals.

Moreover, an AV decoder 10 to decode the video and audio signals from the receiving unit 8 is connected to the AV selector 9. The AV decoder 10 has the function of performing decoding processing (decoding of code) respectively on the video signals and audio signals separated by the AV selector 9 and of generating video data and audio data. The AV decoder 10 is also connected to an audio processing unit 11 and a video processing unit 12.

In addition, the audio processing unit 11 has the function of processing audio signals from the AV decoder 10. The audio processing unit 11, furthermore, has the function of implementing D/A conversion processing (digital/analog conversion processing) under the control of the control unit 4 and of outputting audio of a digital television broadcast program or the like to the speaker unit 3.

Moreover, the video processing unit 12 is connected to the display unit 1 and has the function of implementing D/A conversion processing by the control of the control unit 4 and of switching 2D video and 3D video of a digital television broadcast program or the like and outputting it so as to be displayed on the display unit 1. In addition, the video processing unit 12 is constituted such that when video signals relating to a 3D video are sent from the AV decoder 10, the video processing unit 12 performs processing to separate the video signals relating to the 3D video into left-eye image signals (L) and right-eye image signals (R) by the control of the control unit 4.

Furthermore, the control unit 4 is connected to an illuminance sensor 13 via the bus 5. The illuminance sensor 13 performs the function of measuring the illuminance of the installation location of the liquid crystal television device 100 and has the function of sending the measured illuminance to the control unit 4. The control unit 4 is also constituted so as to adjust the display time of the left-eye image and the right-eye image and the insertion time of the black image inserted between the left-eye image and the right-eye image based on the illuminance measured by the illuminance sensor 13 (measured value), thereby adjusting the luminance visually recognized by the user of the display unit 1 displaying the left-eye image and the right-eye image. Moreover, the video processing unit 12 is constituted such that the left-eye image, the right-eye image, and the black image are sequentially output to the display unit 1 by the control of the control unit 4.

In addition, the control unit 4 is connected to a backlight 14 via the bus 5. The backlight 14 has the function of adjusting the luminance of light (brightness) by the control of the control unit 4.

Furthermore, the glasses 200 preferably include a control unit 20 that performs overall control of the glasses 200, a communication unit 21 to perform wireless communication with the communication unit 2 of the liquid crystal television device 100, a battery 22, a power supply unit 23, a driver for the right eye 24, and a driver for the left eye 25. The communication unit 21, battery 22, power supply unit 23, right-eye driver 24, and left-eye driver 25 are connected to the control unit 20.

Moreover, the right-eye driver 24 is constituted so as to drive a shutter for the right eye 24a composed of a liquid crystal shutter, and the left-eye driver 25 is constituted so as to drive a shutter for the left eye 25a composed of a liquid crystal shutter. In addition, when a 3D video right-eye image is displayed on the display unit 1 of the liquid crystal television device 100, the control unit 20 is constituted such that the left-eye shutter 25a of the glasses 200 is closed and can no longer see, and because this prevents the right-eye image from entering the left eye of the user, control is performed to make observing or viewing of the right-eye image on the display unit 1 possible only with the user's right eye. Furthermore, when the left-eye image is displayed on the display unit 1, the control unit 20 is constituted such that the right-eye shutter 24a of the glasses 200 is closed and can no longer see, and because this prevents the left-eye image from entering the right eye of the user, control is performed to make observing or viewing of the left-eye image on the display unit 1 possible only with the user's left eye. By doing this, it is possible to observe or view the 3D video displayed on the display unit 1 in three dimensions in a state in which the user is wearing the glasses 200.

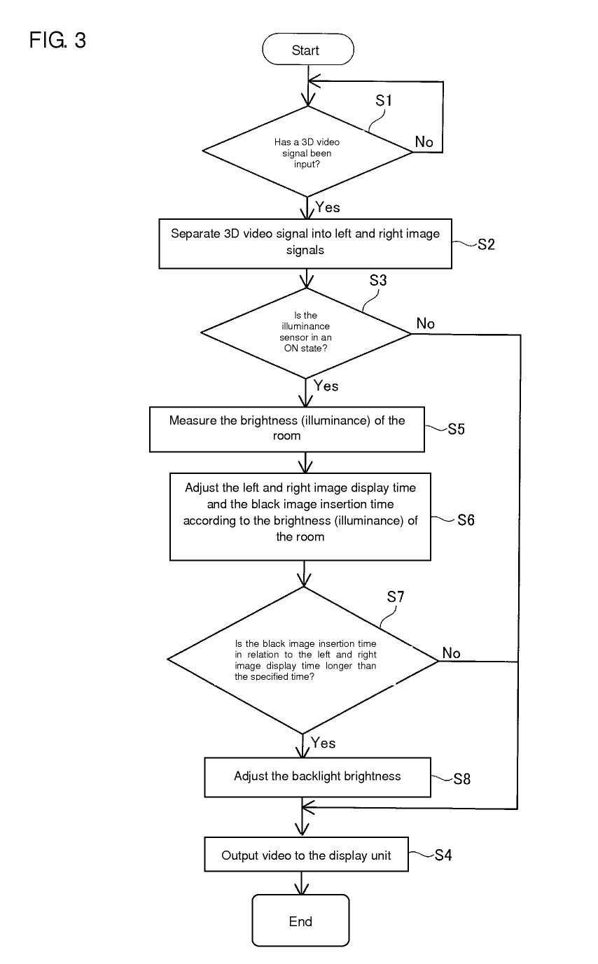

Next, the control operation of the liquid crystal television device 100 according to the first preferred embodiment will be described with reference to FIGS. 3 to 5.

As is shown in FIG. 3, in step S1, until a 3D video signal is input, the determination for this is repeated, and if it is determined that a 3D video signal has been input, then the process advances to step S2.

Next, in step S2, the 3D video signal that is input is separated by the video processing unit 12 into the left-eye image and the right-eye image (left and right image signals), after which the process advances to step S3. In step S3, a determination is made as to whether or not the illuminance sensor is in an ON state. If it is determined in step S3 that the illuminance sensor is not in an ON state (the illuminance sensor is in an OFF state), then the process advances to step S4. Note that if it is determined that the illuminance sensor is not in an ON state (the illuminance sensor is in an OFF state), then the display time of the left-eye image and the right-eye image and the insertion time of the black image are adjusted under the same conditions as when the installation location of the liquid crystal television device 100 is at its brightest.

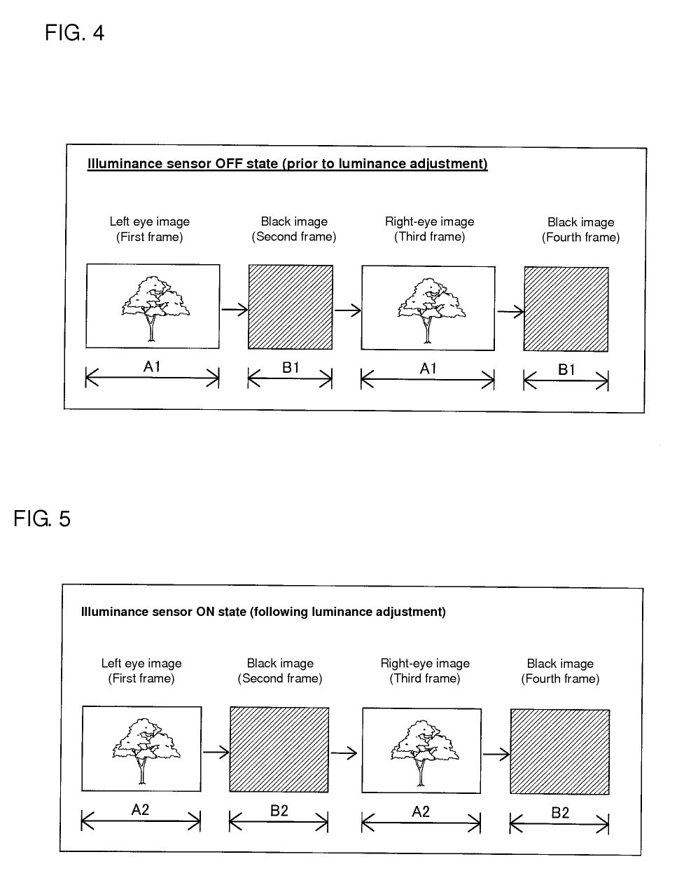

Then, in step S4, the left-eye image of the first frame is displayed on the display unit 1 for the display time A1 as shown in FIG. 4. Next, the black image of the second frame is displayed on the display unit 1 for the insertion time B1. After that, the right-eye image of the third frame is displayed on the display unit 1 for the display time A1 which is the same as the display time of the left-eye image of the first frame. Then, the black image of the fourth frame is displayed on the display unit 1 for the insertion time B1 which is the same as the insertion time of the black image of the second frame. Afterward, the left-eye image, the black image, the right-eye image, and the black image are displayed in sequence on the display 1.

Moreover, as is shown in FIG. 3, if it is determined in step S3 that the illuminance sensor is in an ON state, the process advances to step S5, and the luminance of the installation location of the liquid crystal television device 100 is measured by the illuminance sensor 13. Here, it is assumed that the illuminance of the installation location of the liquid crystal television device 100 is relatively dark compared to when the installation location is at its brightest. Consequently, the luminance of the display unit 1 is judged to be acceptable even if relatively low compared to when the installation location is at its brightest. Then, the process advances to step S6.

Here, with the first preferred embodiment, in step S6, the display time of the left-eye image and the right-eye image and the insertion time of the black image are adjusted according to the illuminance of the installation location of the liquid crystal television device 100. In this case, the illuminance of the installation location of the liquid crystal television device 100 is relatively dark, so the display time of the left-eye image and the right-eye image and the insertion time of the black image are adjusted such that the luminance of the display unit 1 is lowered.

In concrete terms, as is shown in FIG. 5, the display time A2 of the left-eye image of the first frame following luminance adjustment is adjusted so as to be shorter than the display time A1 (see FIG. 4) of the left-eye image of the first frame prior to luminance adjustment. Next, the insertion time B2 of the black image of the second frame following luminance adjustment is adjusted so as to be longer than the insertion time B1 (see FIG. 4) of the black image of the second frame prior to luminance adjustment. Afterward, the display time A2 of the right-eye image of the third frame following luminance adjustment is adjusted so as to be shorter than the display time A1 (see FIG. 4) of the right-eye image of the third frame prior to luminance adjustment. Then, the insertion time B2 of the black image of the fourth frame following luminance adjustment is adjusted so as to be longer than the insertion time B1 (see FIG. 4) of the black image of the fourth frame prior to luminance adjustment. By doing this, the luminance of the display unit 1 following the luminance adjustment becomes lower than the luminance prior to the luminance adjustment by the amount of increase in the insertion time of the black image prior to adjustment and following adjustment of the luminance.

In addition, adjustment is made such that the total time of the display time A1 of the left-eye image (right-eye image) plus the insertion time B1 of the black image prior to luminance adjustment and the total time of the display time A2 of the left-eye image (right-eye image) plus the insertion time B2 of the black image following luminance adjustment are substantially equal. After that, the process advances to step S7.

Next, in step S7, a determination is made as to whether or not the insertion time of the black image is longer than a specified time. If it is determined in step S7 that the insertion time of the black image is longer than the specified time, it is determined that there is a risk of flicker occurring on the display image due to the insertion time of the black image being longer than the specified time. Then, the process advances to step S8.

Next, if it is determined that the insertion time of the black image is longer than the specified time, there is the risk of flicker occurring, so in step S8, the insertion time of the black image is adjusted to be within the specified time, and the luminance of the backlight 14 is adjusted so as to be lower. That is, the luminance of the display unit 1 is adjusted by the combined use of the adjustment of the insertion time of the black image and the adjustment of the luminance of the backlight 14.

Afterward, the process advances to step S4, and in a state in which the adjustment of the insertion time of the black image and the adjustment of the luminance of the backlight 14 are used in combination, the left-eye image, the black image, the right-eye image, and the black image are displayed in sequence on the display unit 1.

Furthermore, if it is determined in step S7 that the insertion time of the black image is not longer than the specified time, after determining that there is no risk of occurrence of flicker, the process advances to step S4, and the images of the first frame to the fourth frame are displayed as shown in FIG. 5. Note that in cases where the illuminance of the installation location of the liquid crystal television device 100 has changed, the illuminance of the installation location is again measured by the illuminance sensor 13, after which the display time of the left-eye image and the right-eye image and the insertion time of the black image are adjusted according to the illuminance of the installation location.

With the first preferred embodiment, as was described above, the luminance is adjusted by adjusting the insertion time B1 (B2) of the black image inserted between the left-eye image and the right-eye image displayed on the display unit 1, so unlike the case of using a contrast amp or the like in order to adjust the luminance, signal processing of the left-eye image and the right-eye image is not performed. Therefore, it is possible to adjust the luminance of the display unit 1 through the adjustment of the insertion time B1 (B2) of the black image while preventing degradation of the signals of the left-eye image and the right-eye image.

Moreover, with the first preferred embodiment, as was described above, adjustment is made such that the insertion time B2 of the black image following luminance adjustment is longer than the insertion time B1 of the black image prior to luminance adjustment, thereby adjusting the post-adjustment luminance to be lower than the pre-adjustment luminance, and adjustment is also made such that the insertion time B2 of the black image following luminance adjustment is shorter than the insertion time B1 of the black image prior to luminance adjustment, thereby adjusting the post-adjustment luminance to be higher than the pre-adjustment luminance. By doing so, the pre-adjustment luminance and the post-adjustment luminance can be made different, so the luminance of the display unit 1 can be adjusted easily.

In addition, with the first preferred embodiment, as was described above, when the luminance is to be adjusted, by adjusting the display time A1 of the left-eye image and the right-eye image, and also adjusting the insertion time B1 of the black image according to the adjusted display time, it is possible to adjust the luminance of the display unit 1 on which the left-eye image and the right-eye image are displayed according to the adjusted display time.

Furthermore, with the first preferred embodiment, as was described above, as a result of the luminance being adjusted such that the total time of the display time A1 of the left-eye image or the right-eye image plus the insertion time B1 of the black image prior to luminance adjustment and the total time of the display time A2 of the left-eye image or the right-eye image plus the insertion time B2 of the black image following luminance adjustment are substantially equal, there is no change in the total time of the display time A1 (A2) of the left-eye image or the right-eye image plus the insertion time B1 (B2) of the black image prior to adjustment and following adjustment of the luminance, so it is possible to adjust the luminance of the display unit 1 without performing control to change the timing of the left-eye image display and the timing of the right-eye image display.

Moreover, with the first preferred embodiment, as was described above, the luminance is adjusted as a result of the insertion time B1 of the black image inserted between the left-eye image and the right-eye image being adjusted based on the illuminance measured by the illuminance sensor 13, so the luminance of the display unit 1 can be adjusted easily based on the illuminance measured by the illuminance sensor 13.

### Second Preferred Embodiment

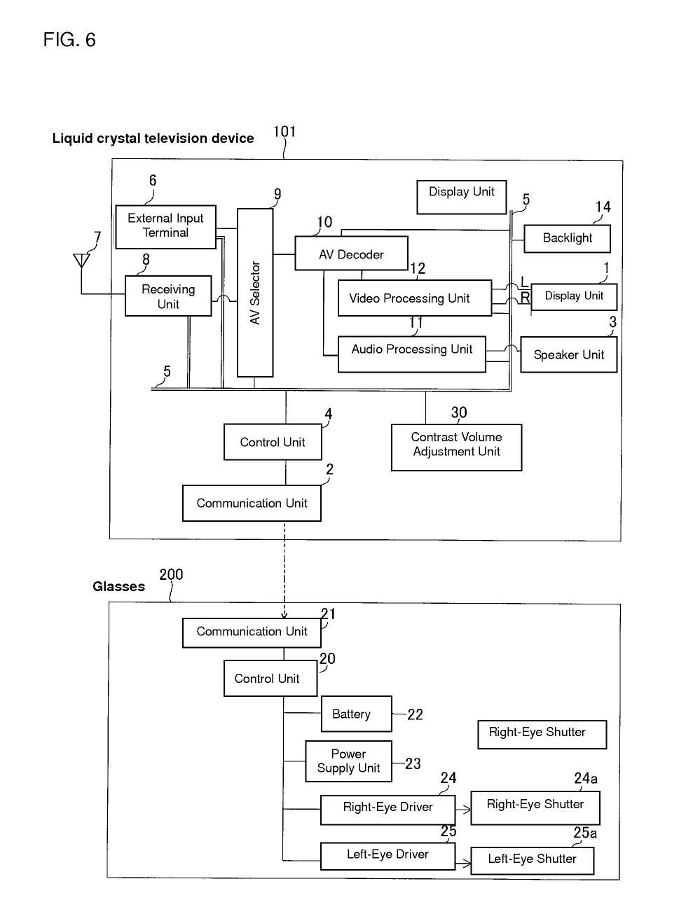

Next, a second preferred embodiment of the present invention will be described with reference to FIG. 6. With the liquid crystal television device 101 according to this second preferred embodiment, unlike the aforementioned first preferred embodiment with which the display time of the left-eye image and the right-eye image and the insertion time of the black image are adjusted based on the illuminance measured by the illuminance sensor, an example will be described in which the display time of the left-eye image and the right-eye image and the insertion time of the black image are adjusted according to the amount of adjustment of the contrast volume when the adjustment operation for the contrast volume is performed by the user.

With the liquid crystal television device 101 according to the second preferred embodiment, the control unit 4 is connected to a contrast volume adjustment unit 30 via the bus 5. Note that the contrast volume adjustment unit 30 is an example of the “luminance adjustment unit” according to a preferred embodiment of the present invention. This contrast volume adjustment unit 30 is constituted such that when the adjustment operation of the contrast volume adjustment unit 30 is performed by the user, signals according to the amount of adjustment of the contrast volume adjustment unit 30 are sent to the control unit 4. In addition, the control unit 4 is constituted such that the display time of the left-eye image and the right-eye image and the insertion time of the black image are adjusted according to the amount of adjustment of the contrast volume adjustment unit 30 by the user. For instance, when an adjustment operation is performed by the user so as to lower the contrast volume, the control unit 4 is constituted so as to shorten the display time of the left-eye image and the right-eye image and also so as to lengthen the insertion time of the black image, thereby adjusting the luminance of the display unit 1 to be lower (darker). Note that the remainder of the constitution of the second preferred embodiment is preferably the same as that of the aforementioned first preferred embodiment.

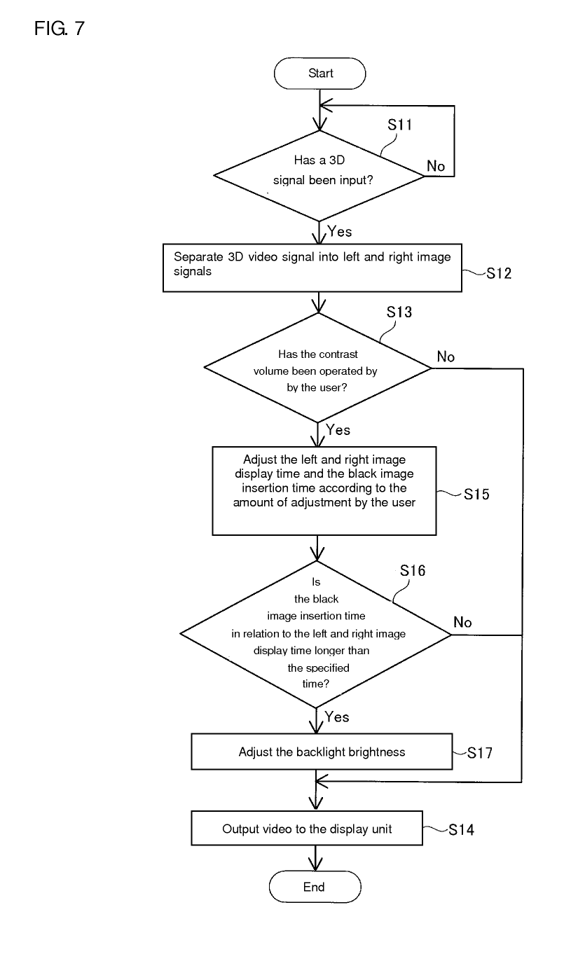

Next, the control operation of the liquid crystal television device 101 according to the second preferred embodiment will be described with reference to FIGS. 7 to 9.

As is shown in FIG. 7, in step S11, until a 3D video signal is input, the determination for this is repeated, and if it is determined that a 3D video signal has been input, the process advances to step S12.

Next, in step S12, the 3D video signal that is input is separated into the left-eye image and the right-eye image (left and right image signals) by the video processing unit 12, after which the process advances to step S13. In step S13, a determination is made as to whether or not the adjustment operation of the contrast volume adjustment unit 30 was performed by the user. If it is determined in step S13 that an adjustment operation of the contrast volume adjustment unit 30 was not performed by the user, the process advances to step S14. Note that if it is determined that there was no adjustment operation of the contrast volume adjustment unit 30 performed by the user, the luminance of the display unit 1 is adjusted to its highest state.

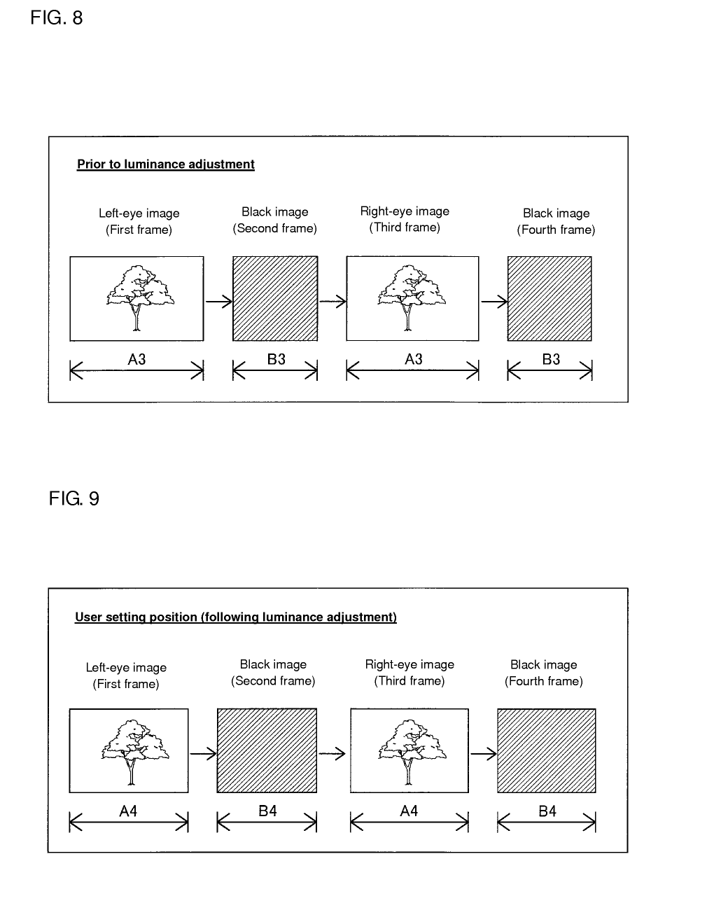

In step S14, as is shown in FIG. 8, the left-eye image of the first frame is displayed on the display unit 1 for the display time A3. Next, the black image of the second frame is displayed on the display unit 1 for the insertion time B3. After that, the right-eye image of the third frame is displayed on the display unit 1 for the same display time A3 as the display time of the left-eye image of the first frame. Then, the black image of the fourth frame is displayed on the display unit 1 for the same insertion time B3 as the insertion time of the black image of the second frame. After that, the left-eye image, the black image, the right-eye image, and the black image are displayed in sequence on the display unit 1.

Furthermore, if it is determined in step S13 that an adjustment operation of the contrast volume adjustment unit 30 was performed by the user, then the process advances to step S15 as shown in FIG. 7.

Next, in step S15, with the second preferred embodiment, the display time of the left-eye image and the right-eye image and the insertion time of the black image are adjusted according to the amount of adjustment of the contrast volume adjustment unit 30 by the user. Here, it is assumed that the contrast volume adjustment unit 30 underwent an adjustment operation by the user to an arbitrary position to make the luminance lower. In this case, as is shown in FIG. 9, the display time A4 of the left-eye image of the first frame following luminance adjustment of the contrast volume adjustment unit 30 is adjusted so as to be shorter than the display time A3 (see FIG. 8) of the left-eye image of the first frame prior to luminance adjustment of the contrast volume adjustment unit 30. Next, the insertion time B4 of the black image of the second frame following luminance adjustment is adjusted so as to be longer than the insertion time B3 (see FIG. 8) of the second frame prior to luminance adjustment. After that, the display time A4 of the right-eye image of the third frame following luminance adjustment is adjusted so as to be shorter than the display time A3 (see FIG. 8) of the right-eye image of the third frame prior to luminance adjustment. Then, the insertion time B4 of the black image of the fourth frame following luminance adjustment is adjusted so as to be longer than the insertion time B3 (see FIG. 8) of the black image of the fourth frame prior to luminance adjustment. Consequently, adjustment is made such that the luminance of the display unit 1 following the luminance adjustment is lower than prior to adjustment by the amount of increase of the insertion time of the black image prior to adjustment and following adjustment of the luminance.

Moreover, adjustment is made such that the total time of the display time A3 of the left-eye image (right-eye image) plus the insertion time B3 of the black image prior to luminance adjustment and the total time of the display time A4 of the left-eye image (right-eye image) plus the insertion time B4 of the black image following luminance adjustment are substantially equal. Afterward, the process advances to step S16.

Next, in step S16, a determination is made as to whether or not the insertion time of the black image is longer than a specified time. If it is determined in step S16 that the insertion time of the black image is longer than the specified time, it is determined that there is the risk of the occurrence of flicker on the display screen due to the insertion time of the black image being longer than the specified time. Then, the process advances to step S17.

Next, if it is determined that the insertion time of the black image is longer than the specified time, there is the risk of the occurrence of flicker, so in step S17, the insertion time of the black image is adjusted so as to be within the specified time, and the luminance of the backlight 14 is adjusted so as to be lower. That is, the luminance of the display unit 1 is adjusted by the combined use of the adjustment of the insertion time of the black image and the adjustment of the luminance of the backlight 14. After that, the process advances to step S14.

Next, in step S14, in a state in which the adjustment of the insertion time of the black image and the adjustment of the luminance of the backlight 14 are used in combination, the left-eye image, the black image, the right-eye image, and the black image are displayed in sequence on the display unit 1.

In addition, if it is determined in step S16 that the insertion time of the black image is not longer than the specified time (within the specified time), after it is determined that there is no risk of flicker occurring, the process advances to step S14, and images from the first frame through the fourth frame are displayed as shown in FIG. 9.

With the second preferred embodiment, as was described above, when an adjustment operation of the contrast volume adjustment unit 30 is performed by the user, the insertion time B3 (B4) of the black image inserted between the left-eye image and the right-eye image is adjusted according to the amount of adjustment of the contrast volume adjustment unit 30, thereby adjusting the luminance; consequently, the luminance of the display unit 1 can be adjusted easily according to the amount of adjustment of the contrast volume adjustment unit 30. Note that the other components, arrangements, effects and advantages of the second preferred embodiment are preferably the same as those of the first preferred embodiment described above.

Note that the preferred embodiments disclosed above are examples in all respects and should be considered to be non-restrictive. The scope of the present invention is indicated not by the description of the aforementioned preferred embodiments but rather by the scope of the claims, and includes all modifications with an equivalent meaning to and within the scope of the claims.

For example, with the aforementioned first and second preferred embodiments, a liquid crystal television device was shown as an example of the video output device of the present invention, but the present invention is not limited to this. For instance, as long as a display unit capable of displaying 3D video is provided, the present invention can also be a video output device other than a liquid crystal television device.

Furthermore, with the first and second preferred embodiments described above, an example was shown in which the control unit preferably performs control to adjust the luminance based on the measured value of the illuminance by the illuminance sensor or the amount of adjustment of the contrast volume, but the present invention is not limited to this. For instance, the control unit may also perform control of luminance adjustment based on the measured value or the amount of adjustment by a device, switch, or the like other than the illuminance sensor or contrast volume.

Moreover, with the first and second preferred embodiments described above, an example of applying a black image was shown as one example of a luminance adjustment image to lower the luminance, but the present invention is not limited to this. For example, as long as it is possible to lower the luminance, an image other than a black image can also be applied.

In addition, with the first and second preferred embodiments described above, an example was shown which preferably adjusts both the insertion time of the black image and the display time of the left-eye image and the right-eye image, but the present invention is not limited to this. For example, while the insertion time of the black image is adjusted, the display time of the left-eye image and the right-eye image does not have to be adjusted.

Furthermore, with the aforementioned first and second preferred embodiments, an example was shown in which adjustment was made such that the total time of the display time of the left-eye image and the right-eye image plus the insertion time of the black image is substantially equal prior to adjustment and following adjustment of the luminance, but the present invention is not limited to this. For example, as long as the luminance is adjusted by adjusting the insertion time of the black image, the total time of the display time of the left-eye image and the right-eye image plus the insertion time of the black image may also be different prior to adjustment and following adjustment of the luminance.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A video output device comprising:
a display unit that displays a left eye image that is transmitted to a left eye and a right eye image that is transmitted to a right eye, and the display unit also outputs, by insertion between the left-eye image and the right-eye image, a luminance adjustment image to lower luminance and that does not contribute to image display; and
a control unit programmed and arranged to perform control such that the luminance is adjusted by adjusting an insertion time of the luminance adjustment image inserted between the left-eye image and the right-eye image displayed on the display unit.

2. The video output device according to claim 1, wherein the control unit is programmed and arranged to perform control to adjust the insertion time of the luminance adjustment image following luminance adjustment to be longer than the insertion time of the luminance adjustment image prior to luminance adjustment, thereby adjusting the post-adjustment luminance to be lower than the pre-adjustment luminance, and which also adjusts the insertion time of the luminance adjustment image following luminance adjustment to be shorter than the insertion time of the luminance adjustment image prior to luminance adjustment, thereby adjusting the post-adjustment luminance to be higher than the pre-adjustment luminance.

3. The video output device according to claim 1, wherein
the luminance adjustment image includes a black image, and
the control unit is programmed and arranged to perform control to adjust the luminance by adjusting the insertion time of the black image inserted between the left-eye image and the right-eye image.

4. The video output device according to claim 3, wherein the control unit is programmed and arranged such that when adjusting the luminance, the control unit performs control to adjust a display time of the left-eye image and the right-eye image and to also adjust the insertion time of the black image according to the adjusted display time.

5. The video output device according to claim 4, wherein the control unit is programmed and arranged to perform control to adjust the luminance such that a total time of the display time of the left-eye image or the right-eye image plus the insertion time of the black image prior to luminance adjustment is substantially equal to a total time of the display time of the left-eye image or the right-eye image plus the insertion time of the black image following luminance adjustment.

6. The video output device according to claim 3, further comprising an illuminance sensor arranged to measure illuminance; wherein
the control unit is programmed and arranged to perform control to adjust the luminance by adjusting the insertion time of the black image inserted between the left-eye image and the right-eye image based on the illuminance measured by the illuminance sensor.

7. The video output device according to claim 3, further comprising a luminance adjustment unit arranged to allow a user to adjust the luminance, wherein the control unit is programmed and arranged to perform control to adjust the luminance by adjusting the insertion time of the black image inserted between the left-eye image and the right-eye image according to an amount of adjustment of the luminance adjustment unit when the adjustment operation of the luminance adjustment unit is performed by the user.
